(19) United States
(12) Patent Application Publication
(10) Pub. No.: US 2008/0040455 A1
(43) Pub. Date: Feb. 14, 2008

(54) MODEL-BASED DEPLOYMENT AND CONFIGURATION OF SOFTWARE IN A DISTRIBUTED ENVIRONMENT

(75) Inventors: Stewart P. MacLeod, Woodinville, WA (US); Joseph Coulombe, Woodinville, WA (US); Perry J. Owen, Woodinville, WA (US); Felix W. Wong, Bellevue, WA (US); Kalpesh S. Patel, Redmond, WA (US); Michael K. Mitchell, Sammamish, WA (US); Gilbert S. Wong, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/463,217

(22) Filed: Aug. 8, 2006

(51) Int. Cl. G06F 15/177

(52) U.S. Cl. 709/220

(57) ABSTRACT

The claimed subject matter provides a system and/or a method that facilitates deploying software in a distributed network efficiently and accurately. An inventory collection component can collect data specific to the distributed network. An automatic software deployment component can automatically deploy software in the distributed network based at least in part upon the collected data, while the deployment of such software is in parallel to increase resource utilization.

### BACKGROUND

Technological advances in computer hardware, software and networking have lead to efficient, cost effective computing systems (e.g., desktop computers, laptops, handhelds, cell phones, servers . . . ) that can communicate with each other from essentially anywhere in the world in order to exchange information. These systems continue to evolve into more reliable, robust and user-friendly systems. As a consequence, more and more industries and consumers are purchasing computers and utilizing them as viable electronic alternatives to traditional paper and verbal media for exchanging information. For example, many industries and consumers are leveraging computing technology to improve efficiency and decrease cost through web-based (e.g., on-line) services. For instance, consumers can search and retrieve particular information (e.g., via a search engine), purchase goods, view bank statements, invoke monetary transactions (e.g., pay a bill on-line), research products and companies, apply for employment, obtain real-time stock quotes, obtain a college degree, download files and applications, transmit correspondence (e.g., email, chat rooms . . . ), etc. with the click of a mouse.

A large and ever-growing amount of computer software is readily available to consumers in light of such a dramatic increase in use, demand, availability, and decrease in cost. Based on such a vast and broad functionality associated with computers, computer software exists for essentially any market, activity, computation, and/or computer-related implementation. For instance, software can be related to accounting, word processing, data management, electronic mail message, virus protection, data synchronization, digital photograph manipulation, media management, operating systems (OS), update control, audio, graphic design, architecture, taxes, browsers, document readers, games, communications, security, networking, etc.

Installation of such software and/or applications can be complex, time-consuming, and costly when the target environment is distributed (e.g., a distributed network, a distributed networked environment, and the like). A distributed network, which is also on the rise based on technological advances, can be a reliable and pervasive high-band network that is arbitrarily distributed (e.g., networked clients) and/or strategically distributed (e.g. networked servers) that can implement software to integrate and manage components associated therewith. Typically, software deployment and installation is a sequential, tedious, and error-prone process. For instance, wizard applications employ a step-by-step installation, wherein a user manually enters various data such as Internet Protocol addresses (IP addresses), name of networks, DNS server names, etc., which can lead to numerous errors and/or typos that can cause an install/deployment to fail. In addition, any errors associated with the deployment of any software will be multiplied since such software is being installed on multiple computers either sequentially or concurrently within a distributed networked environment. For instance, if an incorrect DNS server name is utilized, this error will be repeated for each machine the software is being installed upon. Based on the complexity, which is inherent because of the numerous configurations, settings, and information related to a distributed network, typical installations usually require a costly experienced technician to install and tend to take hours or even days to complete. Software installation/deployment in a distributed networked environment needs a more efficient, error-free, and less expensive process.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate automatically deploying software in a distributed network. An automatic software deployment component can automatically deploy and/or install a portion of software in a distributed environment based at least in part upon specific data, settings, and/or configurations associated therewith. In particular, an inventory collection component can probe the distributed network to retrieve data related to installing and/or deploying software. For example, the data can be Internet Protocol address (IP address), DNS server name, network name, network data, device data, topology data, any suitable data related to the distributed network 106 necessary for software deployment, computer name, firewall data, router data, etc. Based on the collected data, the automatic software deployment component can automatically deploy the software in the distributed environment which can decrease user errors, deployment time, and provide accurate assessments of the distributed network.

In accordance with one aspect of the claimed subject matter, the automatic software deployment component can utilize a workflow engine that is a model-based transaction-oriented workflow engine that allows flexible deployment and configuration of applications and related components on multiple machines in a distributed networked environment. The elements which define and orchestrate the behavior, as well as describe the state of the workflow engine can be modeled and represented as relational entities and stored in the data store (e.g., a SQL database).

In accordance with another aspect of the claimed subject matter, the automatic software deployment component can utilize a verification component that can verify any portion and/or unit of the software deployment within the distributed network. The verification component can allow the deployment of software to be halted upon the detection of an error and/or non-verification of a particular portion of deployment. In accordance with yet another aspect of the claimed subject matter, a report generator can be employed to create documentation related to assessment and/or deployment of software in the distributed network. In other aspects of the claimed subject matter, methods are provided that facilitate automatically assessing a distributed network and/or deploying software in a distributed network.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates automatically deploying software in a distributed network.

FIG. 2 illustrates a block diagram of an exemplary system that facilitates installing software to a distributed network having a plurality of devices based on the specifics of such distributed network.

FIG. 3 illustrates a block diagram of an exemplary system that facilitates collecting information related to a distributed network in order to automatically deploy software therein.

FIG. 4 illustrates a block diagram of an exemplary system that facilitates automatically deploying software in a distributed network and concurrently generating a report and providing verification of deployment.

FIG. 5 illustrates a block diagram of an exemplary system that facilitates parallel deployment of software in a target distributed network utilizing at least one wizard based on data specific to the target distributed network.

FIG. 6 illustrates a block diagram of an exemplary system that facilitates automatically deploying software in a distributed network.

FIG. 7 illustrates a block diagram of an exemplary system that facilitates automatically installing software in a distributed environment utilizing a plurality of wizards.

FIG. 8 illustrates an exemplary user interface that facilitates automatically deploying software in a distributed networked environment.

FIG. 9 illustrates a block diagram of an exemplary model that facilitates employing a model-based transaction oriented workflow engine which allows automatic deployment and configuration of applications and/or software in a distributed networked environment.

FIG. 10 illustrates an exemplary user interface that facilitates providing guidance associated with automatically deploying software in a distributed network.

FIG. 11 illustrates an exemplary methodology that facilitates automatically deploying software in a distributed network.

FIG. 12 illustrates an exemplary methodology for automatically deploying software in a distributed network and concurrently generating a report and providing verification of deployment.

FIG. 13 illustrates an exemplary networking environment, wherein the novel aspects of the claimed subject matter can be employed.

FIG. 14 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” “wizard,” “device,” “engine,” “console,” “generator,” “collector,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

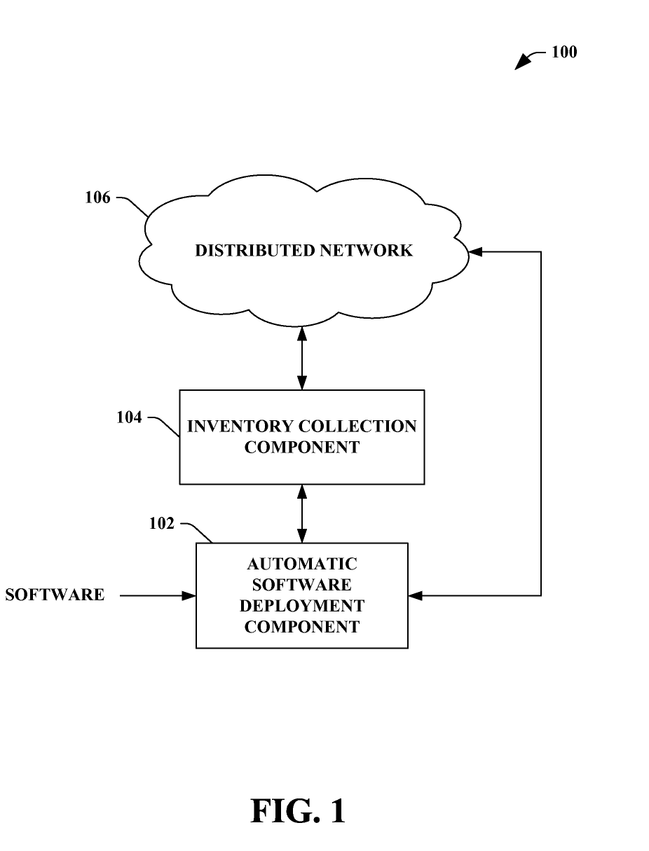

Now turning to the figures, FIG. 1 illustrates a system 100 that facilitates automatically deploying software in a distributed network. The system 100 can include an automatic software deployment component 102 that can receive a portion of software and/or application and automatically deploy such portion in a distributed network 106. The distributed network 106 can be any suitable distributed network, wherein the network can run on a set of machines/components which have complex dependencies on one another. The distributed network 106 can include various devices such as, but not limited to, workstations, servers, desktops, laptops, firewalls, routers, wireless access points, portable digital assistants (PDAs), tablets, pocket PCs, printers, and the like. Additionally, the distributed network 106 can include configuration data specific thereto, wherein such data can be collected by an inventory collection component 104. In particular, the inventory collection component 104 can probe and/or collect data related to the target distributed network 106 such that the data collected facilitates installation of the software and/or application. In one example, the data can be, but is not limited to, Internet Protocol address (IP address), DNS server name, network name, network data, device data, topology data, any suitable data related to the distributed network 106 necessary for software deployment, computer name, firewall data, router data, etc. In another example, the software can be, but is not limited to, any suitable software and/or application, any non-trivial application, any distributed multi-tier application, an operating system (OS), an active directory software, a line of business application (e.g., customer relation management, accounting, share point, etc.), and the like.

The automatic software deployment component 102 can efficiently automatically deploy any suitable software in the distributed network 106 utilizing the collected data specific to the target environment (e.g. the distribute environment 106 that data is collected from). Thus, rather than conventionally having a user manually type and/or enter information necessary for software deployment, the inventory collection component 104 can retrieve deployment-necessary data to allow the automatic software deployment component 102 to deploy such software with little or no user intervention. Moreover, the inventory collection component 104 can provide any suitable data related to the distributed network 106 that can mitigate installation and/or deployment of software. For example, based on the physical topology of the distributed network 106, the automatic software deployment component 102 can implement parallel deployment such that particular steps and/or processes are employed in a specific order/sequence. Moreover, such steps and/or processes can be any suitable steps and/or processes related to deploying software within the distributed network 106 (e.g., file installation, user account setup, approvals, upgrades, license agreements, changing of installation compact discs, etc.). In other words, rather than a sequential and/or step-by-step process for software deployment in a distributed network, the software deployment can be in parallel, wherein multiple steps are done simultaneously so as to efficiently deploy such software and significantly decreasing deployment time.

It is to be appreciated that the utilization of the terminology “deploy software” is not limited to a deployment task nor does it have to be exclusive to software. For instance, the deploy software can be targeted at a change management activity, a decommissioning an entity and/or device, etc. Moreover, a task is not exclusive to software. For example, manual tasks such as changing compact discs (CD's) related to installation can be handled in the process. In addition, software related goals that are manual tasks such as confirming legal licenses can be initiated (e.g., which may only be manifest in a piece of paper). In still another example, a task can also be coordinated across a range of resources that are not limited to hardware/software/service. In particular, several people can be given concurrent tasks and until they confirmed independent completion of them, other downstream tasks with prior dependencies upon those tasks may not be started.

In one aspect in accordance with the subject innovation, various reports can be generated and/or provided related to the automatic deployment of the software in the distributed network 106. For example, a report can be generated based on the collected data associated with the distributed network (e.g., collected via the inventory collection component 104) to illustrate the various data, settings, configurations, devices, etc. within and/or about the distributed network 106. In another example, a report can be provided that illustrates a proposal for a particular distributed network and/or environment. In yet another example, a report can be provided that relates to a proposed deployment strategy of the software based on particular settings. In still another example, a report can be generated to provide data related to the complete installation and/or deployment of the software (e.g., final software settings, data associated with deployment, security related data, etc.). It is to be appreciated that a plurality of reports and/or data can be generated by the system 100 (discussed infra) and the above are examples and are not to be limiting on the claimed subject matter.

In another aspect in accordance with the claimed subject matter, the automatic software deployment component 102 can employ verification techniques to ensure accurate deployment of software. For instance, the deployment steps and/or process can be verified before subsequent steps and/or procedures are taken to progress the deployment of the software in the distributed network. In particular, the system 100 can halt deployment of the software when, for instance, verification is not received and/or an error occurs (discussed infra). Thus, the system 100 can ensure accurate deployment of the software based at least in part upon verifying deployment.

Moreover, the system 100 can include any suitable and/or necessary interface component (not shown and herein referred to as “interface”), which provides various adapters, connectors, channels, communication paths, etc. to integrate the automatic software deployment component 102 into virtually any operating and/or database system(s). In addition, the interface can provide various adapters, connectors, channels, communication paths, etc., that provide for interaction with the automatic software deployment component 102, inventory collection component 104, distributed network 106, and any other device and/or component associated with the system 100.

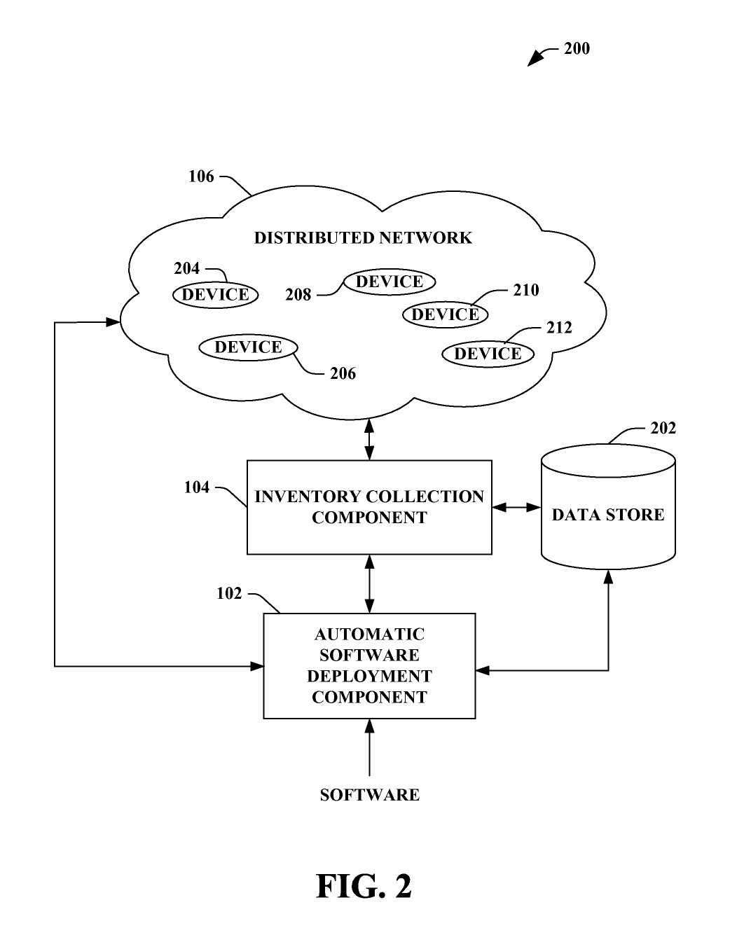

FIG. 2 illustrates a system 200 that facilitates installing software to a distributed network having a plurality of devices based on specifics of such distributed network. The automatic software deployment component 102 can automatically deploy a portion of software in the distributed network 106 based at least in part upon data associated therewith and collected by the inventory collection component 104. In addition, the automatic software deployment component 102 can provide a model-based transaction-oriented workflow engine which allows flexible deployment and configuration of applications and related components on multiple machines in the distributed network 106. For example, the distributed network 106 can include at least one device 204 and/or more than two devices 206-212. To illustrate another example distributed network 106, the device 204 may be a workstation, while the devices 206 and 208 may be different routers and/or programs associated with the device 204. Thus, the devices 204-212 may be a combination of physical devices and software. For instance, the devices 204-212 can be, but are not limited to being, a workstation, a router, a firewall, a program associated with the distributed network 106, a computer, a server, a laptop, a wireless access point, a tablet PC, a PDA, a printer, the Internet, a pocket PC, etc.

The system 200 can further include a data store 202 that can include any suitable data related to the distributed network 106, inventory collection component 104, the automatic software deployment component 102, etc. For example, the data store 202 can be a SQL data store that can include, but not limited to including, configuration data, proposal information, project status, operating system information, application compatibility, Meta data, preferences, hardware inventory, software inventory, plan information, tasks, and/or any other suitable data related to the deployment of software within the distributed network 106. In one example, inventory data can be stored in the data store 202 (e.g., a SQL Server or MSDE database) on a laptop or installed on a server on a customer's network. If the user has multiple customers, the information about each customer can be stored in a separate data store 202 and/or database (e.g., providing the ability to store and act on separate compartmentalized projects). The information stored in each database includes Meta data that describes upgrade rules, operating system information such as version and registered user, hardware/software inventory, configuration information and application compatibility data. The Proposal information can be added at a later time, while the project status can be automatically updated as the work is performed.

It is to be appreciated that the data store 202 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 202 of the subject systems and methods is intended to comprise, without being limited to, these and any other suitable types of memory. In addition, it is to be appreciated that the data store 202 can be a server, a database, a hard drive, and the like.

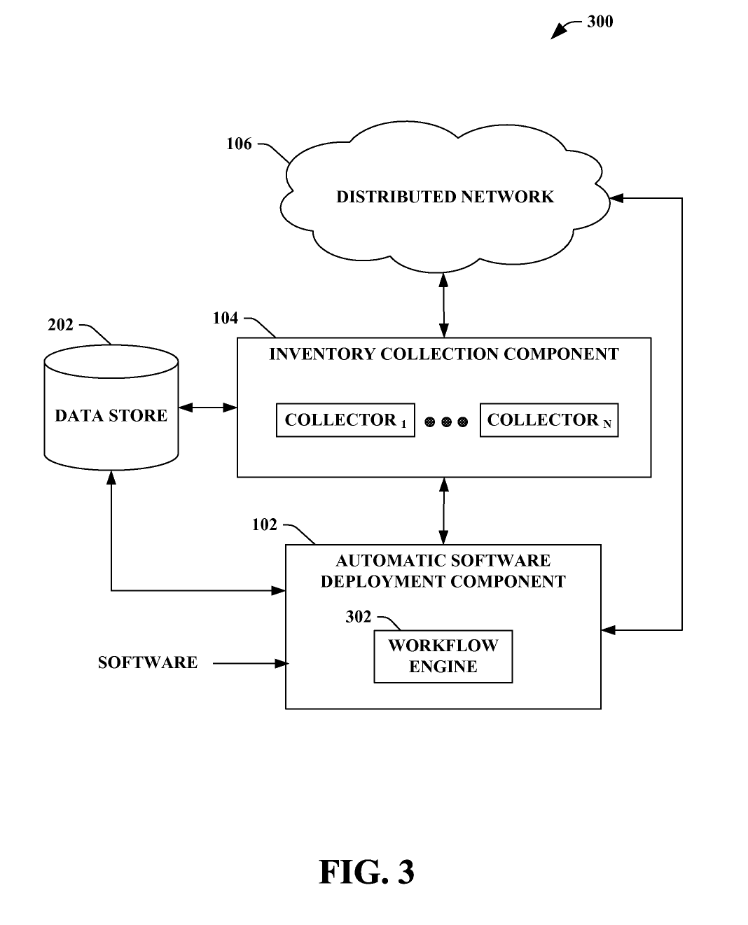

FIG. 3 illustrates a system 300 that facilitates collecting information related to a distributed network in order to automatically deploy software therein. The system 300 can include the automatic software deployment component 102 that can automatically deploy software in the distributed network 106 based upon specific information collected by the inventory collection component 104. The inventory collection component 104 can include any suitable number of collectors such as collector 1 to collector N, where N is a positive integer. In one example that is not limited on the subject innovation, the inventory collection component 104 can include software, hardware, and/or any combination thereof to ascertain data necessary for installation of software. In an example expanding on the previous example, a user confirmation of software licenses purchased can be initiated before continuing with the installation process/procedure. The inventory collection component 104 can include, but is not limited to, a Win32 collector, a Windows Management Instrumentation (WMI) collector, an active directory collector, simple network management protocol (SNMP) collector, etc. (all discussed infra). Moreover, it is to be appreciated that any suitable collector can be utilized in order to ascertain data related to installing and/or deploying software/applications.

The automatic software deployment component 102 can include a workflow engine 302, wherein the workflow engine 302 is a model-based transaction-oriented workflow engine that allows flexible deployment and configuration of applications and related components on multiple machines in a distributed networked environment. At the heart of the system 300 is a model-driven, transaction-oriented workflow engine 302. The elements which define and orchestrate the behavior, as well as describe the state of the workflow engine 302 can be modeled and represented as relational entities and stored in the data store 202 (e.g., a SQL database). More specifically, a workflow graph describing possible workflow execution paths required to deploy the desired set of software components can be modeled and encoded at a Meta-level, and is defined in terms of sets of precedence constraints, priorities and desired configuration states.

The system 300 can define a domain-specific model for deploying and configuring server applications, an application associated with directory services, messaging systems, electronic messaging systems, operating systems, server monitoring software and/or applications, and the like. The precedence constraints in the model define the order that tasks can be executed in. The use of precedence constraints enables multiple steps to be executed in parallel which, in turn, serves to reduce the total time for deployment. Because state changes are transacted, and tasks are executed based on declared precedence constraints, the model is an inherently scalable, consistent and fault tolerant solution to coordinating long running processes. Additionally, because models are declarative in nature, they are completely independent of the physical topology that the components are to be deployed to. This allows the end user to choose which services will be co-located or installed on dedicated systems. It is to be appreciated that any arbitrary collection of software components can be represented and deployed using the meta-level model-based approach associated with the system 300.

The following sections describe the core concepts around which the workflow modeling process can be constructed. The task sequence, or workflow, consists of an arbitrary number of steps. The steps can control the flow of execution and identify what task should be executed. Each step is executed whenever all of its precedence constraints have been satisfied. Thus, this approach provides an inherently parallel execution model. Any steps that have satisfied the precedence constraints can automatically be executed in parallel to reduce the total execution time.

Each step in a workflow can have zero or more precedence constraints. The set of precedence constraints associated with a given step defines the necessary and sufficient state conditions required for the step to execute. When a step is executed it has an execution status of “NotRun”, “Running”, “Success”, “Failure” or “Completed.” “NotRun” means that the step has not yet been executed. “Running” indicates the step is currently executing, and its execution completion status is currently unknown. “Success” indicates that the step has completed execution successfully based upon process exit code. “Failure” indicates that the step failed for any reason and is indicated by a non-zero exit code. “Completed” can indicate an execution has occurred regardless if such execution is a “Success” or a “Failure.”

Each precedence constraint can also define the required execution status of its predecessor step. For example, a workflow can be defined where Task A has no precedence constraints and is therefore eligible for immediate execution. Task B has a precedence constraint that requires that Task A be completed with an execution status of “Success.” Task C has a precedence constraint that requires that Task A be completed with an execution status of “Failure.” Complex constraints can be created from a combination of “Success”, “Failure” and “Completion” statuses.

While Steps control the flow of execution, Tasks describe what to execute. Each Task, for instance, can be implemented as either a Process, Batch File, SQL Server stored procedure or manual operation. The return code from the task can define the execution status for the step that a given task is associated with. Tasks can optionally define a compensation command (e.g., compensatory action) that is implicitly executed upon failure. The user can provide the status code of manual operations.

For instance, a task often utilizes parameters that can define a file path/name, server, user name or password. A task can have one or more parameters associated with it that are stored in the database. Parameters values can be communicated and shared between Tasks. This allows the output filename for Task A to be used as the input filename for Task B.

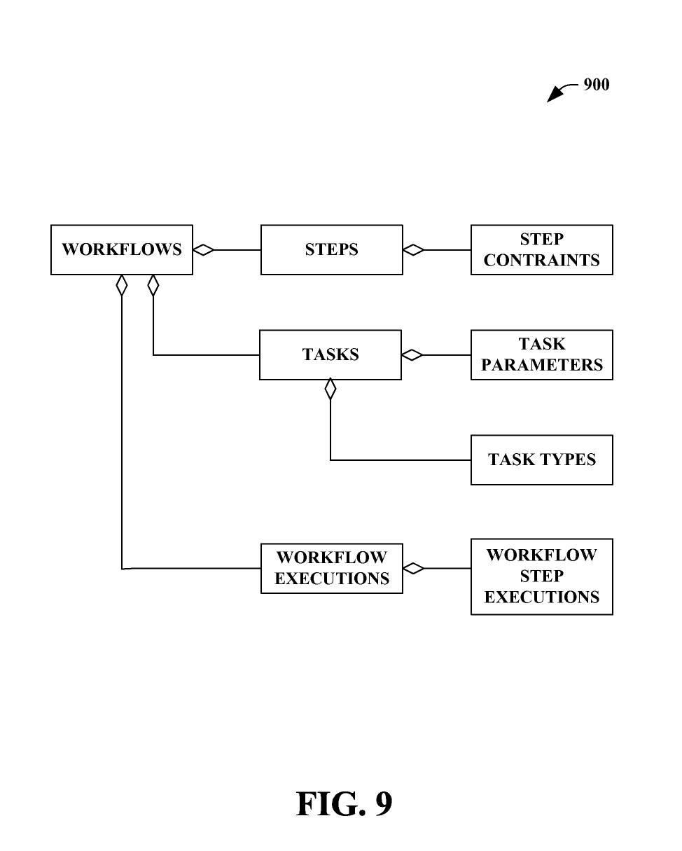

A workflow can be executed many times. Each execution of a workflow is persisted in the data store 202 (e.g., a SQL database in a Workflow executions table). This summarizes the overall status of the workflow. Detailed information about the execution of each step/task can be stored in a WorkflowStepExecutions table. Whenever a task completes execution, a stored procedure updates the state in the WorkFlowStepExecutions table. A SQL Server trigger on this table can query the WorkflowStepExecutions table to identify and execute any other steps that have all of their precedence constraints satisfied. If the workflow is completed, it can write the final status to the Workflow executions table. Collectively, the concepts described above can be organized logically as depicted in an entity-relation model (e.g., refer to FIG. 9).

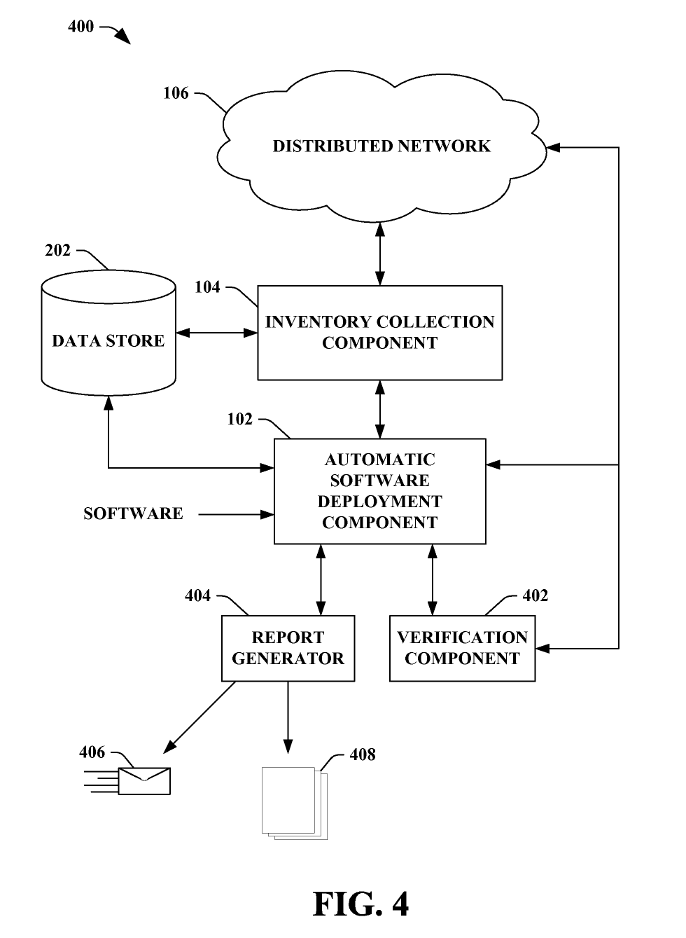

FIG. 4 illustrates a system 400 that facilitates automatically deploying software in a distributed network and concurrently generating a report and providing verification of deployment. The system 400 can include a verification component 402 that can verify any portion and/or unit of the software deployment within the distributed network 106. The verification component 402 ensures that a first unit of deployment is successful before the subsequent unit of deployment is initiated. By verifying each unit of deployment, the system 400 provides efficient and accurate installation and/or deployment of software within the distributed network. In another example, the verification component 402 can verify each step so that the model can halt when a step is incomplete and/or contains an error. Based on a detected error, the system 400 can request user intervention and subsequently return to automatic mode and/or deployment for the software.

The system 400 can further include a report generator 404 that can generate any suitable report and/or documentation related to the software deployment, the distributed network 106, and/or the system 400. For example, various documents, graphs, charts, presentations, graphics, emails, web pages, and/or other visual materials can be provided by the report generator 404. For instance, such documentation and/or reports can facilitate allowing a user to view at least one of a particular deployment strategy, a current status of the distributed network, a proposal for software deployment, a summary on the software deployment, etc. For instance, a distributed network can be evaluated such that a report can be generated that provides the current status of the distributed network. In particular, the report and/or documentation generated can be utilized to evaluate the current security, integrity, composition, and/or topology of the distributed network, wherein the report and/or documentation can provide in-depth guidance to providing advice related to the distributed network. In other words, a report can allow a user to identify particular problems and/or issues related to security, integrity, composition, and/or topology which may not have been identified albeit for the report.

Specifically, the report can include any suitable data related to the distributed network 106 and/or deployment of software. The reports and/or documents can be a word processing document, a graph, a picture, a chart, an illustration, and/or any combination thereof, etc. The report generator 402 can provide the report via email 406, paper documents 408, HTML, a website, text messages, and/or any other techniques associated with displaying and/or receiving data. For example, a report can be generated and sent to an email address providing information related to, but not limited to, the distributed network and/or deploying software in the distributed network. In addition, the report can be generated and then distributed to various entities, targets, users, developers, testers, systems, components, databases, etc. (discussed infra)

The system 400 can further include a log component (not shown) that can log various data associated with the system 400. For instance, the log component can log data such as, but not limited to, configurations/settings of the distributed network 106, devices within the distributed network 106, IP addresses, DNS server names, network names, software installed and/or deployed, user profiles, deployment settings, deployment progress, proposals, summaries, hardware and/or software topology, deployment sequence, computer names, any suitable data related to the system 400, etc.

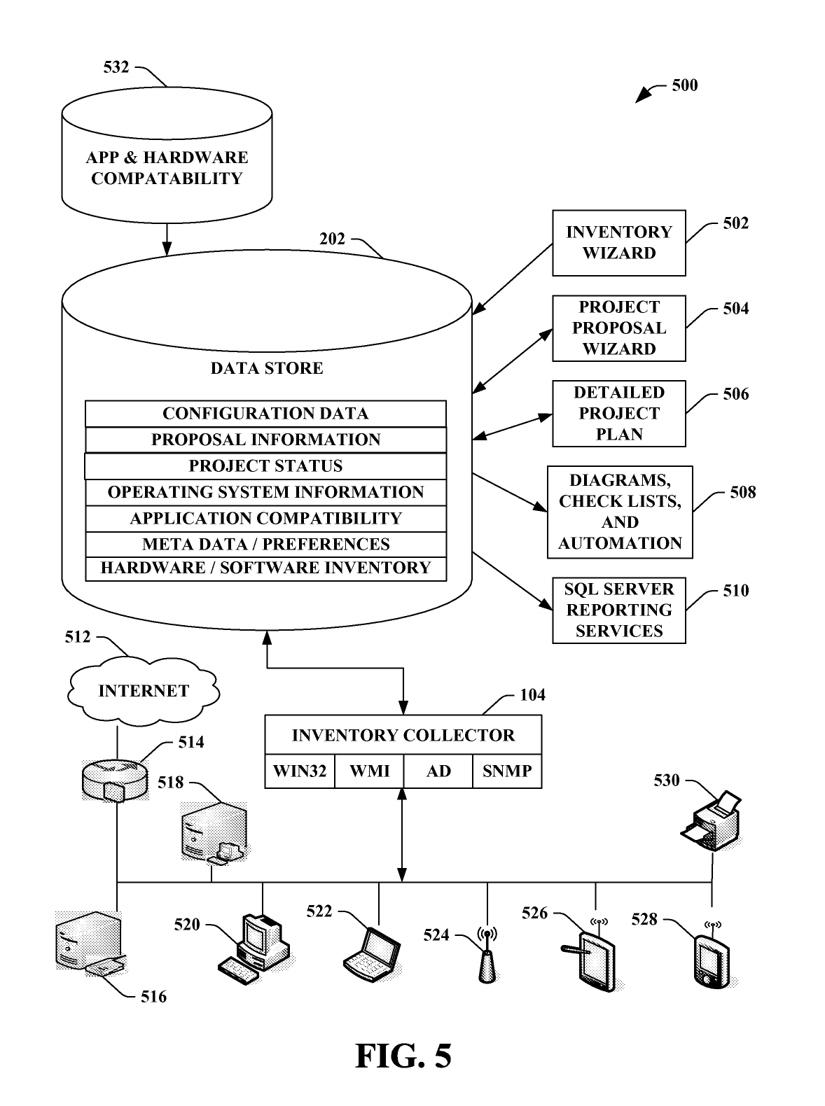

FIG. 5 illustrates a system 500 that facilitates parallel deployment of software in a target distributed network utilizing at least one wizard based on data specific to the target distributed network. The system 500 is designed to make it easy for users to quickly create compelling proposals to migrate core networking and messaging infrastructure. Users often invest 8-12 hours to assess the customer's current environment in order to prepare a detailed project proposal. The system 500 makes a detailed inventory of the servers, workstations and network devices in a customer's environment and then generates a detailed project proposal and automated the actual deployment based on the inventory and configuration data collected.

Moreover, the system 500 includes a mechanism to define, store, and evaluate graphs utilizing a relational model that has been translated and encoded as a relational database schema. This model, which can be also referred to as a meta-model, can describe any arbitrary software deployment workflow. The system 500 is an innovative mechanism to evaluate all possible workflow nodes eligible for execution utilizing a complex relational query. The result setoff this query can return all workflow nodes which can be eligible for execution. Moreover, the precedence constraints (discussed below) in the model can define the order that a task can be executed. By implementing the precedence constraints, multiple steps can be executed in parallel which can reduce the total time for software deployment. The model is also a declarative model which can provide the separation between the physical topology and the software components that are being deployed. This can allow an end user to choose which services will be co-located or installed on dedicated systems. The system 500 provides a complete model of the software components to be deployed and represented in terms of precedence constraints, priorities, and desired configuration states. These entities are organized into a workflow graph which can describe all possible execution paths required to deploy said software components in the distributed networked environment. For instance, any suitable acyclic graph can be utilized to evaluate the particular inventory of a distributed network to ascertain the opportunities for parallel installation and/or deployment. In addition, the model-based approach accommodates the execution of both idempotent and non-idempotent tasks (e.g., the property of idempotency can mean that repeated executions to a task has the same effect as one execution of the task), which can provide greater flexibility to users in the creation of models.

The system 500 can include the data store 202 (e.g., a SQL Server database), an inventory wizard 502, the inventory collector 104, a project proposal wizard 504, detailed project plan 506, diagrams, task check lists and automation 510.

For example, a user can plug a laptop into the network or install an Inventory, Assessment & Proposal Tool on a machine on the network. The user can run the Inventory Wizard 502 to quickly specify the information the user would like to collect. The user can choose the default which uses LAN Manager, Active Directory, WMI and SNMP to collect hardware and software information associated with the inventory collector 104, which can give a detailed understanding of all of the assets installed in this environment.

The inventory data is stored in the data store 202 (e.g., a SQL Server or MSDE database) on a laptop or installed on a server on the customer's network. The information about each customer can also be stored in a separate database. The information stored in each database includes Meta data that describes upgrade rules, operating system information such as version and registered user, hardware/software inventory, configuration information and application compatibility data. The Proposal information can be added later, while the project status can be automatically updated as the work is performed.

It is to be appreciated that the inventory collector 104 can provide any suitable data associated with the distributed network having devices, such as, but not limited to, a router 514, a workstation 516, a server 518, a computer 520, a laptop 522, a wireless access point 524, a tablet PC 526, a pocket PC 528, and a printer 530.

The inventory collector 104 can include a Unicode inventory collector, which can be a C# program running on the user machine that collects detailed information using Win32, WMI, Active Directory, service control manager, DNS, OSPF (open shortest path first), and SNMP. The data to be collected is specified using the Inventory Wizard 502 and stored in the SQL Server database (e.g., data store 202). It remotely connects to each machine using RPC, DCOM, LDAP or any other suitable protocols (e.g., HTTP, web services, WSmanagement, WMI, etc.). The Unicode Inventory collector reads the data stored in the SQL Server database, executes each of collectors and inserts the data into the SQL Server inventory database.

In a particular example, some platforms may not be compatible with certain protocols and/or legacy platforms may not provide the capabilities of network connectivity (e.g. legacy operating systems which do not suport RPC, DCOM or directory services, etc.). In other words, such higher level protocols may not be utilized and an agent can be deployed, wherein such agent can create a file and employ SMB (server message blocks) for file sharing. In paticualr, legacy platforms may not support RPC, DCOM or WMI. If inventory information is required for these machines, a C++ Legacy Collector must be deployed on each machine and a central file share created. This collector only returns a subset of information using Win32 and the registry. The data can be written to a network share where it is imported into the inventory database.

The inventory collector 104 can also utilize a Win32 collector. Using the Win32 API NetServerEnum( ), Windows servers, workstations and laptops are identified on the network. Win32 APIs are used to check for Active Directory, Domains and clustering. Information is read from the registry using the standard APIs. In addition, some network configuration information is read from DNS, DHCP and WINS.

The inventory collector 104 can further include a Windows Management Instrumentation (WMI) collector. The collector uses WMI to get detailed hardware and software inventory and OS configuration information from each machine it has permissions on. This includes information about local accounts, BIOS, disk drives, memory, processor information, software inventory, network configuration and QFEs.

An active directory collector can also be implemented by the inventory collector 104. LDAP queries are executed against Active Directory if present. Queries against the Active Directory User object are used to retrieve information such as the user's name, address, phone number, location and manager. In addition, the computer object is used to identify servers, workstations, domain controllers and global catalogs.

In yet another example, the inventory collector 104 can further include a simple network management protocol (SNMP) collector for network devices. The SNMP collector is used to identify IP addressable network devices such as routers, switches, and fire walls using standard SNMP MIBS.

If an internet connection is available, the system 500 can check for updates to the application compatibility database 532 using the Application Compatibility Toolkit (ACT 4.0) via the Internet 512. If no connection is available, the system can utilize the version current at the time of the product is made available to the public.

The Project Proposal Wizard 504 lets the user decide what type of work should be included as part of this bid. It could include upgrading NT4 Domains to Active Directory, Upgrading Exchange 5.5 to Exchange 2003, NT Server 4 to Windows Server 2003, ISA and upgrading client workstations to Windows XP using BDD. It is to be appreciated that the above examples are not to be limiting on the subject innovation and that any upgrading for software can be included. The final result is a detailed draft proposal that the partner can give to the customer for consideration.

The detailed project plan 506 is designed to reduce the time on-site required by the user. It will also enhance the user's reputation by allowing to proactively identify known compatibility problems and recommended remediation before the upgrade/migration begins.

The detailed inventory and proposal information in the database is used to automatically generate professional diagrams, checklists and automation 508 that summarize both the current and proposed architecture. These diagrams make it easy for both the user and the customer to understand exactly what has been deployed in production. It automatically recommends specific deployment topologies based on the customer's environment and recommends how to most efficiently reuse existing IT assets. It also includes detailed check lists that can be used by less experienced consultants on the partner's staff. Finally, unattended setup scripts (SIF files, Response Docs, etc) are generated to reduce the time to install and configure the network, messaging and management servers. It also automatically generates verification steps before and after each task in the deployment task sequence. In addition, the system 500 can include a SQL server reporting service 510 can be provided.

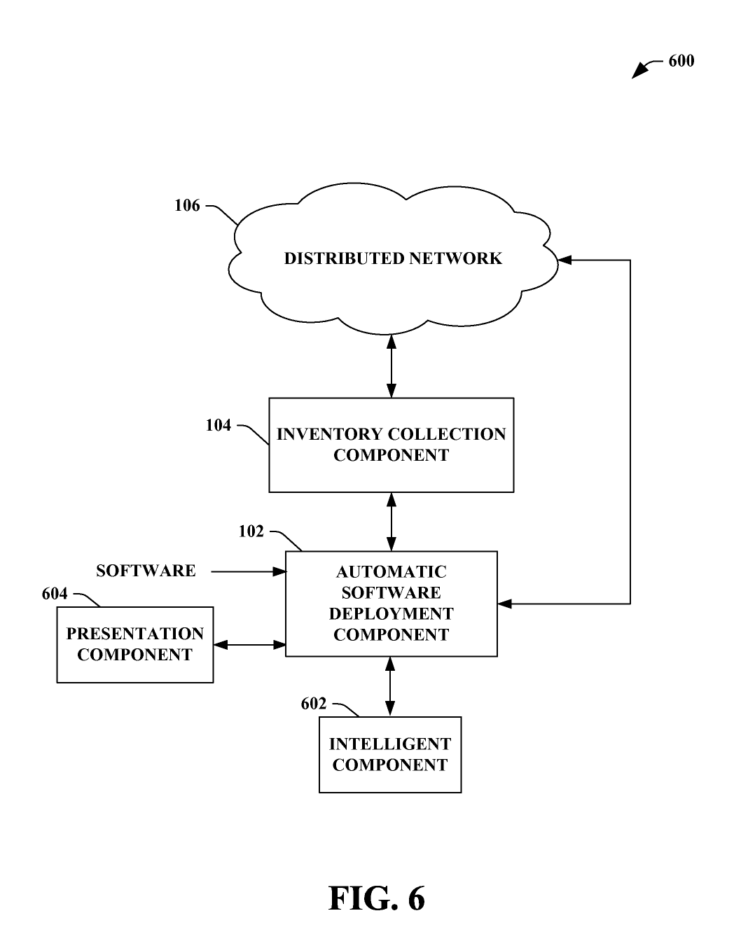

FIG. 6 illustrates a system 600 that employs intelligence to facilitate automatically deploying software in a distributed network. The system 600 can include the automatic software deployment component 102, the inventory collection component 104, and the distributed network 106. It is to be appreciated that the automatic software deployment component 102, the inventory collection component 104, and the distributed network 106 can be substantially similar to respective components, and networks described in previous figures. The system 600 further includes an intelligent component 602. The intelligent component 602 can be utilized by the automatic software deployment component 102 to facilitate automatically deploying software in the distributed network based on data collected by the inventory collection component 104. For example, the intelligent component 602 can infer distributed network settings, distributed network devices, configurations associated with the distributed network, user preferences, device settings, IP addresses, DNS server names, computer names, network names, proposals for deployment, deployment strategies, sequences for deployment of software, software settings/configuration, collectors to employ within the distributed network, etc.

It is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

The automatic software deployment component 102 can further utilize a presentation component 604 that provides various types of user interfaces to facilitate interaction between a user and any component coupled to the automatic software deployment component 102. As depicted, the presentation component 604 is a separate entity that can be utilized with the automatic software deployment component 102. However, it is to be appreciated that the presentation component 604 and/or similar view components can be incorporated into the automatic software deployment component 102 and/or a stand-alone unit. The presentation component 602 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the automatic software deployment component 102.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

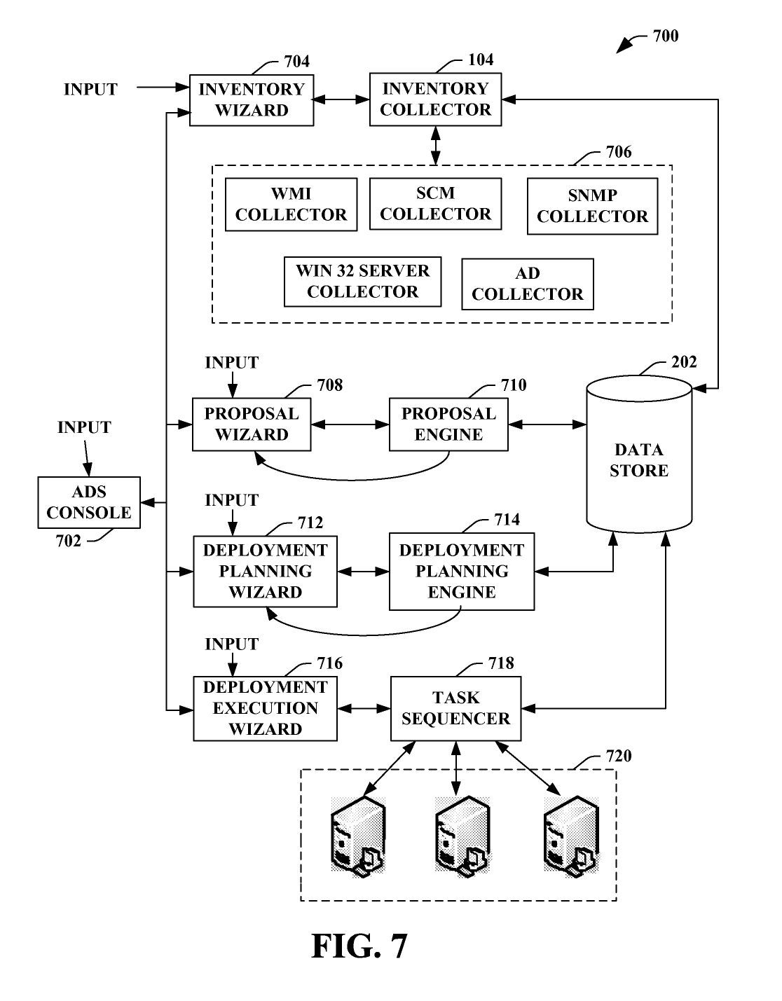

FIG. 7 illustrates a system 700 that facilitates automatically installing software in a distributed environment utilizing a plurality of wizards. The system 700 can utilize a plurality of wizards (e.g., an interactive computer program which can act as an interface to lead a user through a complex task utilizing step-by-step dialogs) to facilitate automatically deploying software in a distributed network. The system 700 can be driven by a central console, referred to as the assessment and deployment solution console (ADS) 702. The ADS console 702 can receive inputs in order to guide a user through the assessment of the distributed network and eventual deployment of software.

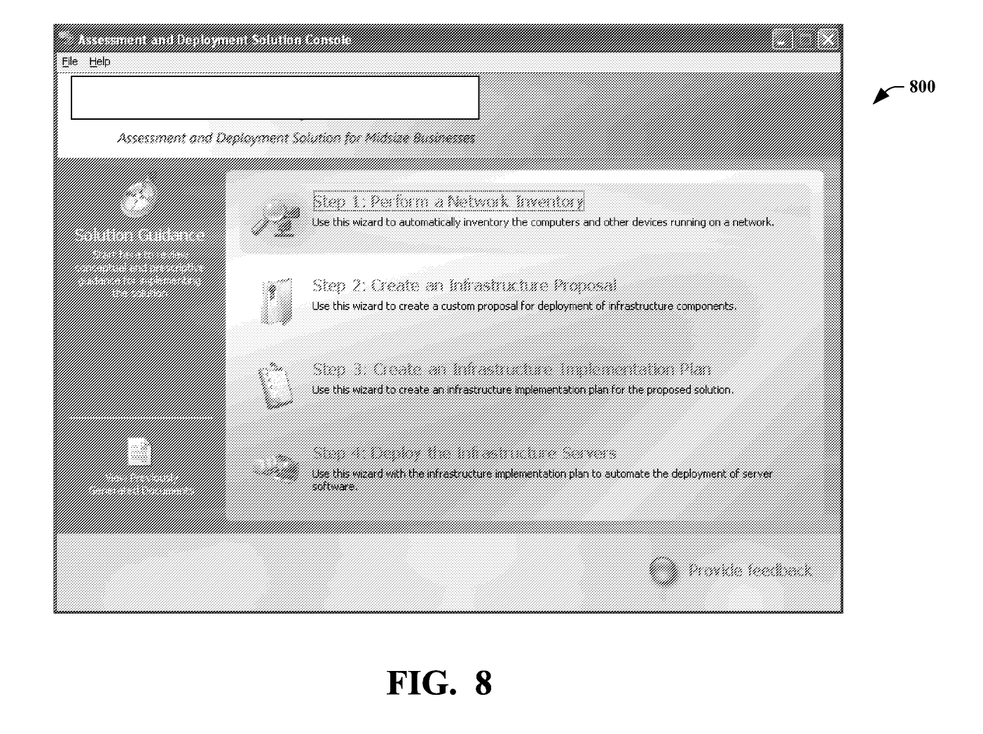

Turning quickly to FIG. 8, a user interface 800 that facilitates automatically deploying software in a distributed networked environment is illustrated. The user interface 800 can be an example of the ADS console 702, wherein various options can be available to a user such as, but not limited to, performing a network inventory, creating an infrastructure proposal, creating an infrastructure implementation plan, and/or deploying the infrastructure servers. It is to be appreciated that the user interface 800 is solely depicted as an example, and the claimed subject matter is not to be so limited. In other words, there are numerous user interface functions, aesthetics, and/or details available, and such minor nuances are to be considered within the scope of the subject innovation.

Referring back to FIG. 7, based on the input received, various wizard applications can provide further guidance in assessment and deployment of software in the distributed environment. An inventory wizard 704 can be launched, wherein the inventory collector 104 can be employed to ascertain data related to the distributed environment. For example, the inventory wizard 704 can receive input from a user to specify a distributed network to collect inventory data. The inventory collector 104 can probe and collect various data associated with devices and/or the distributed network in general utilizing various collectors 706. The collectors can be any suitable hardware, software, and/or any combination thereof to collect any suitable data required to assess the distributed network and/or deploy software into the distributed network. As depicted for example, the collectors 706 can be a WMI collector, an service control manager (SCM )collector that identifies roles of a particular device and/or machine in the distributed network (e.g., messaging server, main controller, DNS server, etc.), an SNMP collector, a Win32 server collector, and an AD collector (all discussed supra). Moreover, upon collection of any inventory data, the data can be stored in the data store 202 (as well as any plan information, meta data, preferences, tasks, proposal information, hardware inventory, software inventory, configuration data, etc.).

The system 700 can further include a proposal wizard 708 that can facilitate evaluation of the distributed network. The proposal wizard 708 can receive inputs that enable a proposal engine 710 to generate a proposal and/or deployment solution based on the collected inventory data stored in the data store 202. The proposal can be, but is not limited to, a document, an email, an electronic document, a graphic, an illustration, a picture, a chart, etc. It is to be appreciate that the proposal wizard 708 can facilitate creating and/or generating any material related to the distributed network current state (e.g. security, software location, network settings, network configurations, devices within the distributed network, etc.), a proposed solution in relation to software needs, a proposal for security related to the environment, trouble-shooting the environment, etc.

The system 700 can also include a deployment planning wizard 712 that can employ a deployment planning engine 714 to assist in generating implementation documents that illustrate the proposed deployment of software in the distributed environment. The implementation document can be any suitable documents related to the possible deployment plan such as, but not limited to, graphs, charts, presentations, pictures, word processing documents, email, web graphics, etc. It is to be appreciated that the deployment planning wizard 712 can create and/or generate any suitable documentation that facilitates illustrating the planned deployment of software, the current improvements to be deployed in the distributed environment, and/or any other possible manipulation ascertained based on the current state of the distributed environment (e.g. updates, upgrades, security improvements, etc.). In one example, the system 700 can utilize an acyclic graph from the inventory data collected (e.g., an inventory graph) to calculate the most efficient path in order to ascertain the opportunities for parallel deployment (e.g. executing something remotely, locally, etc.).

The system 700 can further include a deployment execution wizard 716 that facilitates deploying software in the target distributed environment. The deployment execution wizard 716 can utilize a task sequencer 718 that can efficiently deploy software in the distributed environment to various machines 720 based at least in part upon the deployment planning engine 714 and the deployment planning wizard 712. It is to be appreciated that the data store 202 can be utilized by at least one of the inventory wizard 704, the proposal wizard 708, the deployment planning wizard 712, and the deployment execution wizard 716 as a transactional oriented workflow engine to allow simultaneous execution of programs and/or agents in parallel so software can be deployed efficiently.

FIG. 9 illustrates a model 900 that facilitates employing a model-based transaction oriented workflow engine which allows automatic deployment and configuration of applications and/or software in a distributed networked environment. The model 900 logically organizes the claimed subject matter concepts in an entity-relation model as depicted in FIG. 9. The model 900 is a transaction-oriented workflow engine that allows flexible deployment and configuration of applications and related components on multiple machines in a distributed networked environment. It is to be appreciated that the workflow entity-relation model 900 described various concepts discussed in FIG. 3.

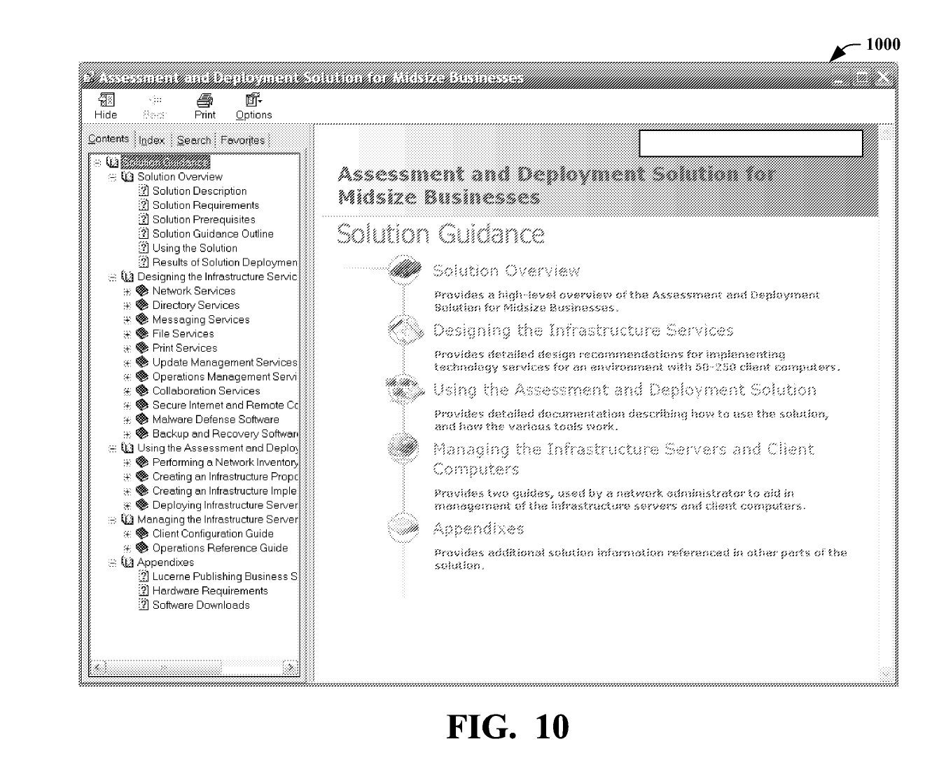

FIG. 10 illustrates a user interface 1000 that facilitates providing guidance associated with automatically deploying software in a distributed network. The user interface 1000 is an exemplary user interface that can provide help and/or guidance in assessing a distributed network and deploying software in a distributed network. For instance, the user interface 1000 can be a wizard application that provides at least one of the following: solution overview; designing the infrastructure services; using the assessment and deployment solution; managing the infrastructure servers and client; and appendixes. It is to be appreciated that the user interface 1000 is for exemplary purposes only and the claimed subject matter is not to be so limited.

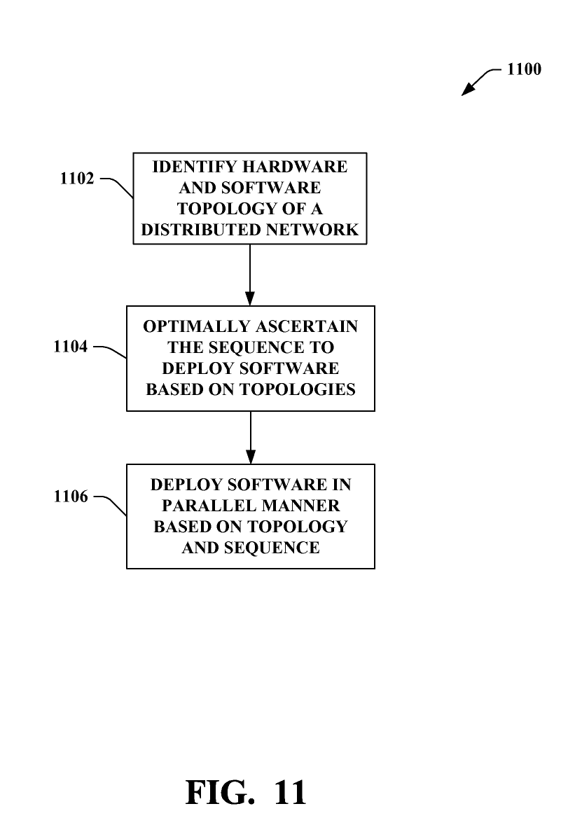

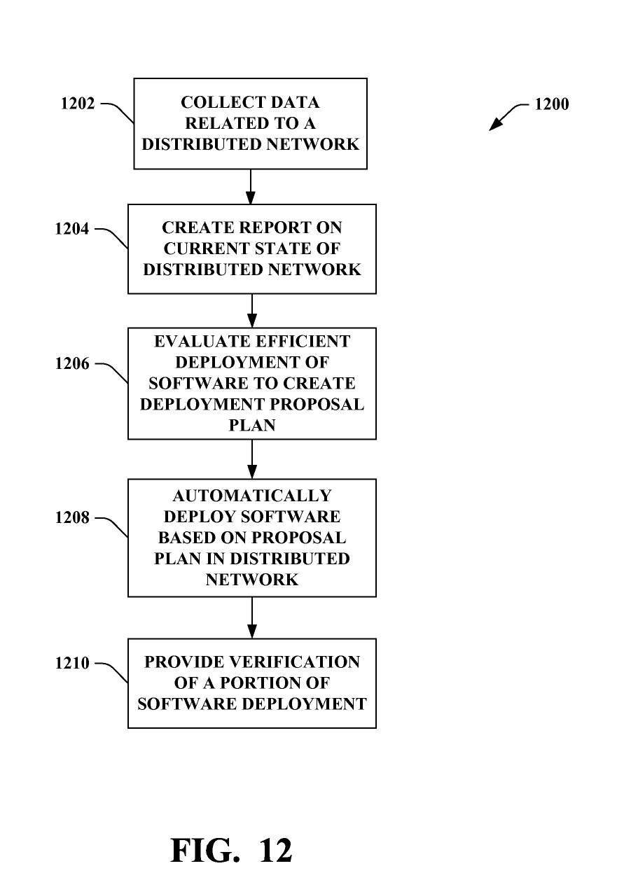

FIGS. 11-12 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 11 illustrates a methodology 1100 for automatically deploying software in a distributed network. At reference numeral 1102, a hardware topology and/or a software topology of a distributed network can be identified. The distributed network can be any suitable distributed network, wherein the network can run on a set of machines/components which have complex dependencies on one another. The distributed network can include various devices such as, but not limited to, workstations, servers, desktops, laptops, firewalls, routers, wireless access points, portable digital assistants (PDAs), tablets, pocket PCs, printers, and the like. Based on the multiple configurations associated with the various devices, the hardware and/or software topology can greatly enhance the deployment of software in such a distributed environment. For instance, the hardware and/or software topology of the distributed network can be identified and/or collected by at least one collector. The inventory collector can include software, hardware, and/or any combination thereof to ascertain data necessary for deployment of software. The inventory collector can include, but is not limited to, a Win32 collector, a WMI collector, an active directory collector, SNMP collector, etc. Moreover, it is to be appreciated that any suitable collector can be utilized in order to ascertain data related to installing and/or deploying software/applications.

At reference numeral 1104, a sequence of deployment for software can be optimally ascertained based on the collected data and topology related to the distributed network. For example, based on the physical topology of the distributed network parallel deployment can be implemented such that particular steps and/or processes are employed in a specific order/sequence. Moreover, such steps and/or processes can be any suitable steps and/or processes related to deploying software within the distributed network (e.g., file installation, user account setup, approvals, upgrades, etc.). In other words, rather than a sequential and/or step-by-step process for software deployment in a distributed network, the software deployment can be in parallel, wherein multiple steps are done simultaneously so as to efficiently deploy such software and significantly decreasing overall deployment time.

At reference numeral 1106, the software can be deployed in a parallel manner based on the topology and distributed network collected data and the optimally ascertained sequence. Thus, the software can be efficiently and automatically deployed in the distributed network utilizing the collected data specific to the target environment (e.g., the distribute environment that data is collected from). Thus, rather than conventionally having a user manually type and/or enter information necessary for software deployment, such information is automatically collected and retrieved to allow automatic deployment of such software with little or no user intervention.

FIG. 12 illustrates a methodology 1200 for automatically deploying software in a distributed network and concurrently generating a report and providing verification of deployment. At reference numeral 1202, data associated with a distributed network can be collected. The data can be related to the target distributed network such that the data collected facilitates installation/deployment of the software and/or application. In one example, the data can be, but is not limited to, Internet Protocol address (IP address), DNS server name, network name, network data, device data, topology data, any suitable data related to the distributed network necessary for software deployment, computer name, firewall data, current distributed network state, security data associated with the distributed network, router data, etc.

At reference numeral 1204, a report can be created based on the current state of the distributed network. For example, the distributed network can be evaluated based at least in part upon the collected data, wherein such data can shed insight on possible upgrades, manipulations, updates, security breaches, etc. Thus, a proposal can be created and/or generated such that the current state of the distributed network can be identified and logged for evaluation purposes. The proposal/report can be, but is not limited to, a document, an email, an electronic document, a graphic, an illustration, a picture, a chart, etc. It is to be appreciate that the proposal can facilitate creating and/or generating any material related to the distributed network current state (e.g., security, software location, network settings, network configurations, devices within the distributed network, etc.), a proposed solution in relation to software needs, a proposal for security related to the environment, trouble-shooting the environment, etc.

Continuing at reference numeral 1206, the deployment of software can be efficiently evaluated to create a deployment proposal plan. In other words, various data associated with the distributed network can point toward an optimized deployment strategy, wherein such strategy can be documented as a proposal for presentation, illustration, and/or for records. Similar to the report on the current state of the distributed network, the deployment proposal plan can be, but is not limited to, a document, an email, an electronic document, a graphic, an illustration, a picture, a chart, etc. The deployment proposal plan can facilitate illustrating the planned deployment of software, the current improvements to be deployed in the distributed environment, and/or any other possible manipulation ascertained based on the current state of the distributed environment (e.g. updates, upgrades, security improvements, etc.). In one example, an acyclic graph from the inventory data collected (e.g., an inventory graph) can be utilized to calculate the most efficient path in order to ascertain the opportunities for parallel deployment (e.g. executing something remotely, locally, etc.). At reference numeral 1208, the software can be deployed automatically in the distributed network based on the deployment proposal plan.

At reference numeral 1210, verification of at least a portion of the software deployment can be provided. The verification can ensure that a first unit of deployment is successful before the subsequent unit of deployment is initiated. By verifying each unit of deployment, efficient and accurate installation and/or deployment of software within the distributed network can be ensured. In another example, each step can be verified so that the model can halt when a step is incomplete and/or contains an error. Based on a detected error, user intervention can be requested and subsequently return to automatic mode and/or deployment for the software.

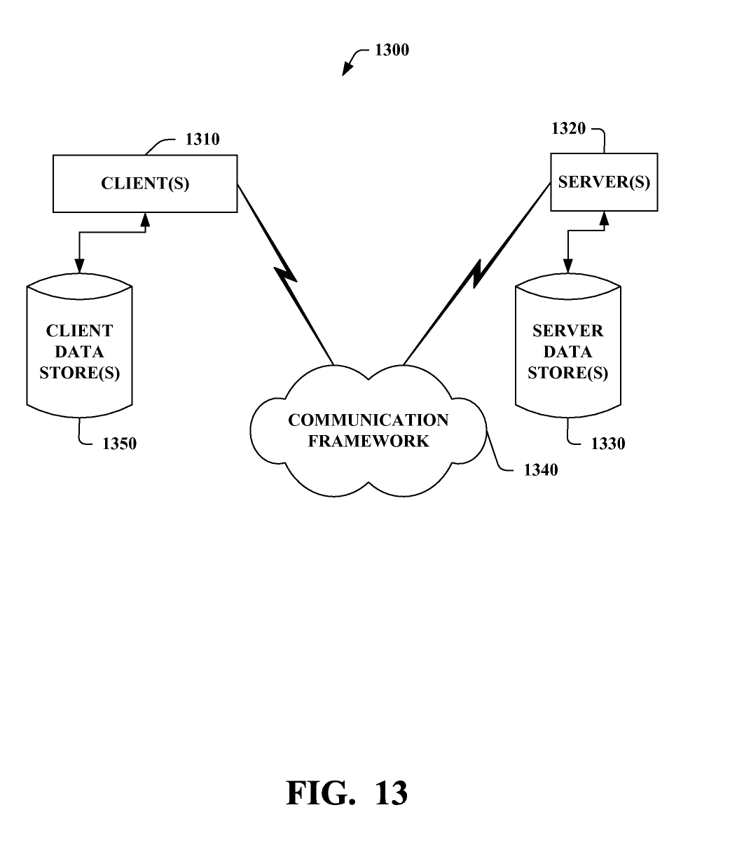

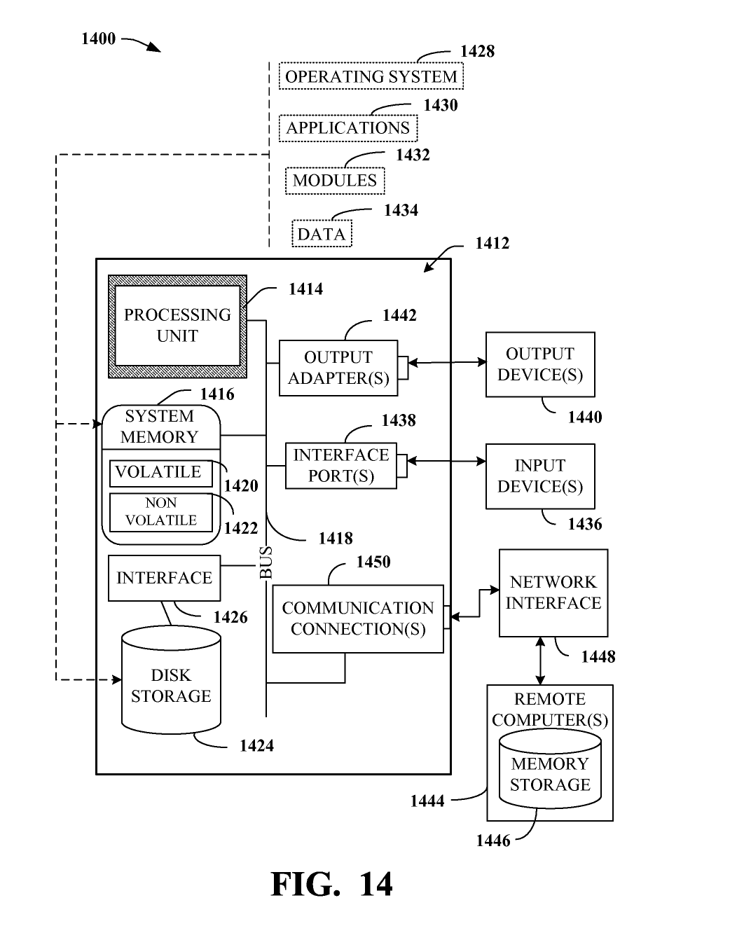

In order to provide additional context for implementing various aspects of the claimed subject matter, FIGS. 13-14 and the following discussion is intended to provide a brief, general description of a suitable computing environment in which the various aspects of the subject innovation may be implemented. For example, an automatic software deployment component that automatically deploys and configures software in a distributed networked environment, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 13 is a schematic block diagram of a sample-computing environment 1300 with which the claimed subject matter can interact. The system 1300 includes one or more client(s) 1310. The client(s) 1310 can be hardware and/or software (e.g., threads, processes, computing devices). The system 1300 also includes one or more server(s) 1320. The server(s) 1320 can be hardware and/or software (e.g., threads, processes, computing devices). The servers 1320 can house threads to perform transformations by employing the subject innovation, for example.

One possible communication between a client 1310 and a server 1320 can be in the form of a data packet adapted to be transmitted between two or more computer processes. The system 1300 includes a communication framework 1340 that can be employed to facilitate communications between the client(s) 1310 and the server(s) 1320. The client(s) 1310 are operably connected to one or more client data store(s) 1350 that can be employed to store information local to the client(s) 13 10. Similarly, the server(s) 1320 are operably connected to one or more server data store(s) 1330 that can be employed to store information local to the servers 1320.

With reference to FIG. 14, an exemplary environment 1400 for implementing various aspects of the claimed subject matter includes a computer 1412. The computer 1412 includes a processing unit 1414, a system memory 1416, and a system bus 1418. The system bus 1418 couples system components including, but not limited to, the system memory 1416 to the processing unit 1414. The processing unit 1414 can be any of various available processors. Dual microprocessors and other multiprocessor architectures also can be employed as the processing unit 1414.

The system bus 1418 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1416 includes volatile memory 1420 and nonvolatile memory 1422. The basic input/output system (BIOS), containing the basic routines to transfer information between elements within the computer 1412, such as during start-up, is stored in nonvolatile memory 1422. By way of illustration, and not limitation, nonvolatile memory 1422 can include read only memory (ROM), programmable ROM (PROM), electrically programmable ROM (EPROM), electrically erasable programmable ROM (EEPROM), or flash memory. Volatile memory 1420 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1412 also includes removable/non-removable, volatile/non-volatile computer storage media. FIG. 14 illustrates, for example a disk storage 1424. Disk storage 1424 includes, but is not limited to, devices like a magnetic disk drive, floppy disk drive, tape drive, Jaz drive, Zip drive, LS-100 drive, flash memory card, or memory stick. In addition, disk storage 1424 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1424 to the system bus 1418, a removable or non-removable interface is typically used such as interface 1426.

It is to be appreciated that FIG. 14 describes software that acts as an intermediary between users and the basic computer resources described in the suitable operating environment 1400. Such software includes an operating system 1428. Operating system 1428, which can be stored on disk storage 1424, acts to control and allocate resources of the computer system 1412. System applications 1430 take advantage of the management of resources by operating system 1428 through program modules 1432 and program data 1434 stored either in system memory 1416 or on disk storage 1424. It is to be appreciated that the claimed subject matter can be implemented with various operating systems or combinations of operating systems.

A user enters commands or information into the computer 1412 through input device(s) 1436. Input devices 1436 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1414 through the system bus 1418 via interface port(s) 1438. Interface port(s) 1438 include, for example, a serial port, a parallel port, a game port, and a universal serial bus (USB). Output device(s) 1440 use some of the same type of ports as input device(s) 1436. Thus, for example, a USB port may be used to provide input to computer 1412, and to output information from computer 1412 to an output device 1440. Output adapter 1442 is provided to illustrate that there are some output devices 1440 like monitors, speakers, and printers, among other output devices 1440, which require special adapters. The output adapters 1442 include, by way of illustration and not limitation, video and sound cards that provide a means of connection between the output device 1440 and the system bus 1418. It should be noted that other devices and/or systems of devices provide both input and output capabilities such as remote computer(s) 1444.

Computer 1412 can operate in a networked environment using logical connections to one or more remote computers, such as remote computer(s) 1444. The remote computer(s) 1444 can be a personal computer, a server, a router, a network PC, a workstation, a microprocessor based appliance, a peer device or other common network node and the like, and typically includes many or all of the elements described relative to computer 1412. For purposes of brevity, only a memory storage device 1446 is illustrated with remote computer(s) 1444. Remote computer(s) 1444 is logically connected to computer 1412 through a network interface 1448 and then physically connected via communication connection 1450. Network interface 1448 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1450 refers to the hardware/software employed to connect the network interface 1448 to the bus 1418. While communication connection 1450 is shown for illustrative clarity inside computer 1412, it can also be external to computer 1412. The hardware/software necessary for connection to the network interface 1448 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates deploying software in a distributed network, comprising:
an inventory collection component that collects data specific to the distributed network; and
an automatic software deployment component that automatically deploys software in the distributed network based at least in part upon the collected data, the deployment of such software is in parallel to increase resource utilization.

2. The system of claim 1, the distributed network is a network that runs at least one of a device and a component which have a complex dependency on one another.

3. The system of claim 2, the device is at least one of the following: a workstation; a server; a desktop; a laptop; a firewall; a router; a wireless access point; a portable digital assistant (PDA); a tablet PC; a pocket PC; a printer; a portion of installed software; software; and an input device.

4. The system of claim 1, the collected data is at least one of the following: distributed network configuration data; settings associated with the distributed network; an Internet Protocol (IP) address; a DNS server name; a network name; network data; device data; topology data; software topology data; hardware topology data; a computer name; firewall data; and router data.

5. The system of claim 1, further comprising a workflow engine that is a model-driven, transaction-oriented workflow engine which allows flexible deployment and configuration of at least one of an application and software on a machine in the distributed network.

6. The system of claim 5, a state of the workflow engine is modeled and represented as a relational entity stored in a SQL database.

7. The system of claim 5, the workflow engine utilizes a workflow graph that describes a workflow execution path required to deploy software, the workflow graph is modeled and encoded at a Meta-level, and is defined by at least one of a precedence constraint, a priority, and a configuration state.

8. The system of claim 1, further comprising a verification component that verifies a unit of the software deployment within the distributed network.

9. The system of claim 8, the verification component ensures that a first unit of deployment is successful before a subsequent unit of deployment is initiated.

10. The system of claim 8, the verification initiates a halt upon a detection of an error and provides at least one of the following: a termination of deployment; a manual intervention; and a halt of deployment until the error is corrected.

11. The system of claim 1, further comprising a report generator that can create at least one document associated with the distributed network.

12. The system of claim 11, the document is at least one of a graph, a chart, a presentation, a graphic, an email, a web page, a visual material, a word processing document, and an electronic document.

13. The system of claim 11, the report generator creates at least one document related to at least one of the following: a current state of the distributed network; a current configuration of the distributed network; a setting within the distributed network; a device listing associated with the distributed network; a security assessment of the distributed network; an assessment of the distributed network; a proposal for the distributed network; an upgrade for the distributed network; a software listing for the distributed network; an update for the distributed network; a deployment planning strategy for software in the distributed network; a recommendation related to improving the distributed network; an evaluation of the current state of the distributed network; and an evaluation of the future state after deployment of software in the distributed network.

14. The system of claim 1, further comprising at least one of the following: a WMI collector that retrieves a detailed hardware and software inventory and operating system configuration information from a device the collector has permissions to; a SCM collector that identifies a role a machine is in within the distributed network; a simple network management protocol (SNMP) collector that identifies an IP addressable network device; a Win32 collector that identifies at least one of a server, a workstation, and a laptop on the distributed network; and an Active Directory (AD) collector that retrieves information from Active Directory.

15. They system of claim 1, further comprising at least one wizard that provides at least one of the following: a retrieval of data associated with deploying software in the distributed network; a retrieval of data associated with assessing the distributed network; a proposal related to the distributed network; a deployment plan associated with the distributed network; a deployment execution of the software within the distributed network; and a assessment and deployment solution console to provide guidance to a user.

16. The system of claim 1, the collected data specific to the distributed network is shared to facilitate accessing such data during deployment.

17. A computer-implemented method that facilitates deploying software in a distributed environment, comprising:
identifying at least one of a hardware topology and a software topology of a distributed network;
ascertaining an optimal sequence to deploy software based on at least one of the hardware topology and the software topology; and
deploying the software in a parallel manner based on at least one of the optimal sequence, the hardware topology, and the software topology.

18. The method of claim 17, further comprising:
creating a report associated with the distributed network; and
verifying a portion of software deployment within the distributed network.

19. The method of claim 17, further comprising utilizing a model-driven, transaction-oriented workflow engine to allow flexible deployment and configuration of software on a machine in the distributed network.

20. A computer-implemented system that facilitates deploying a portion of software in a distributed network, comprising:
means for collecting data specific to the distributed network;
means for automatically deploying software in the distributed network based at least in part upon the collected data; and
means for deploying such software in parallel to increase resource utilization.
